(19) United States
(12) Patent Application Publication
(10) Pub. No.: US 2007/0083904 A1
(43) Pub. Date: Apr. 12, 2007

(54) AUDIO/VIDEO OUTPUT ADJUSTING SYSTEM AND METHOD OF THE SAME

(76) Inventor: Wen-Yu Lo, Taoyuan (TW)

Correspondence Address: HOFFMAN WARNICK & D'ALESSANDRO, LLC, 75 STATE STREET, 14TH FLOOR, ALBANY, NY, 12207, US

(21) Appl. No.: 11/536,133

(22) Filed: Sep. 28, 2006

(30) Foreign Application Priority Data
Oct. 7, 2005 (TW) 094135151

(51) Int. Cl. H04N 7/173; H04N 11/02; H04B 1/66; H04N 11/04; H04N 7/12

(52) U.S. Cl. 725/100; 375/240.12; 725/131

(57) ABSTRACT

The invention discloses an audio/video output adjusting system including a decoder, a memory unit, a parser and a processor. The decoder is used for decoding an inputted audio/video sequence as a digital sequence. The memory unit is used for storing a look-up table. The parser is used for receiving the digital sequence, determining a program type of the digital sequence according to the look-up table and outputting the digital sequence as a video sequence and an audio sequence. The processor is used for receiving the video sequence and the audio sequence and, according to the program type, selectively adjusting the video sequence and/or the audio sequence by a predetermined mode.

### BACKGROUND OF THE INVENTION

1. Field of the Invention

The invention relates to an audio/video output adjusting system and method of the same, and more particularly to an audio/video output adjusting system capable of selectively auto-adjusting the audio/video output of an inputted audio/video sequence according to different program types.

2. Description of the Prior Art

Recently, since science and technology have been improved and developed continuously, the digital TV is getting more and more popular. In current, there are three kinds of digital video broadcasting, such as Advanced Television Systems Committee (ATSC) of United States, Digital Video Broadcasting-Terrestrial (DVB-T) of Europe and Integrated Services Digital Broadcasting-Terrestrial (ISDB-T) of Japan. The digital TV can recognize and determine the program type of each received signal, and then the program type is provided for the program or event as message description.

Furthermore, since the programs have various types, when a user change one program type to another each time, he/she has to adjust the audio and/or video correspondingly to acquire preferred audio-visual quality. However, because most of the users are not an expert in the field of audio-visual effect, they usually do not know how to adjust the audio and/or video for different program type. It's really inconvenient and confusing for the users. If the digital TV can auto-adjust the audio/video output for each program when acquiring the program type, it will be more convenient for the user.

Therefore, the scope of the invention is to provide an audio/video output adjusting system and method of the same to solve the above-mentioned problems.

### SUMMARY OF THE INVENTION

The scope of the invention is to provide an audio/video output adjusting system and method of the same capable of selectively auto-adjusting the audio/video output of an inputted audio/video sequence according to different program types, such that no matter the user changes the program to which type, the audio-visual quality of each program can always maintain perfect status.

According to one preferred embodiment of the invention, the audio/video output adjusting system includes a decoder, a memory unit, a parser and a processor. The decoder is used for decoding an inputted audio/video sequence as a digital sequence. The memory unit is used for storing a look-up table. The parser is used for receiving the digital sequence, determining a program type of the digital sequence according to the look-up table and outputting the digital sequence as a video sequence and an audio sequence, respectively. The processor is used for respectively receiving the video sequence and the audio sequence and, according to the program type, selectively adjusting at least one of the video sequence and the audio sequence by a predetermined mode.

Accordingly, when the user changes one program type to another, the invention will auto-determine the program type of the current inputted audio/video sequence and further utilize the processor to selectively adjust at least one of the video sequence and the audio sequence, such that the audio-visual quality of each program can always maintain perfect status.

The advantage and spirit of the invention may be understood by the following recitations together with the appended drawings.

### BRIEF DESCRIPTION OF THE APPENDED DRAWINGS

FIG. 1 is a functional block diagram illustrating an audio/video output adjusting system according to a first preferred embodiment of the invention.

FIG. 2 is a schematic diagram illustrating the look-up table shown in FIG. 1.

FIG. 3 is a flowchart showing the audio/video output adjusting method according to the first preferred embodiment of the invention.

### DETAILED DESCRIPTION OF THE INVENTION

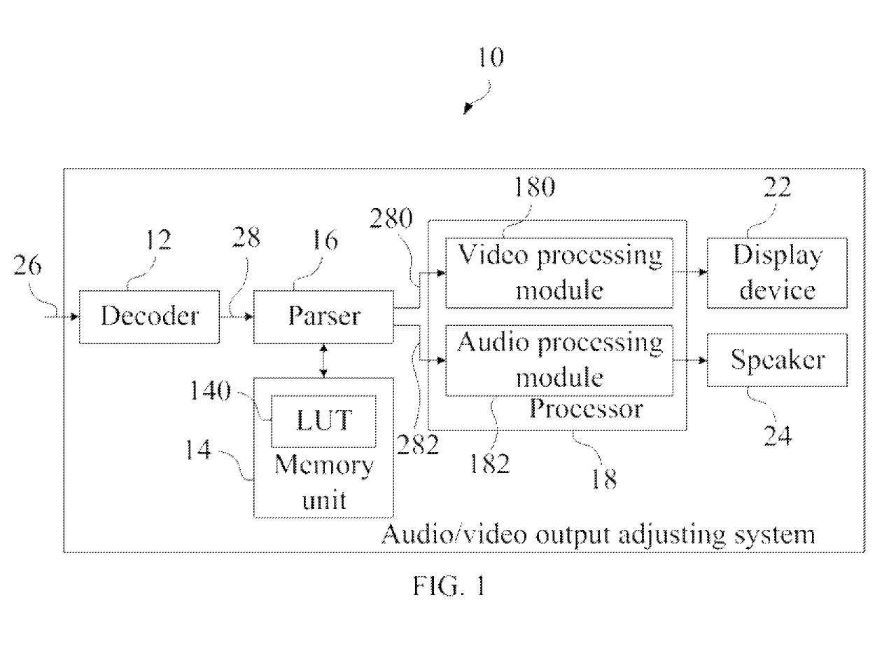

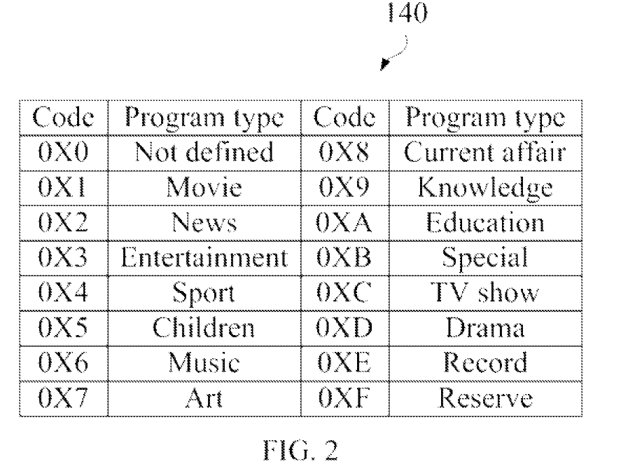

Referring to FIGS. 1 and 2, FIG. 1 is a functional block diagram illustrating an audio/video output adjusting system 10 according to a first preferred embodiment of the invention. FIG. 2 is a schematic diagram illustrating the look-up table 140 shown in FIG. 1. As shown in FIG. 1, the audio/video output adjusting system 10 includes a decoder 12, a memory unit 14, a parser 16 and a processor 18. The decoder 12 is used for decoding an inputted audio/video sequence 26 as a digital sequence 28. The memory unit 14 is used for storing a look-up table (LUT) 140. As shown in FIG. 2, the look-up table 140 records M codes and M program types, each of the M codes is corresponding to one of the M program types, respectively, and M is a natural number. In this embodiment, the memory unit 14 is a flash memory, and the look-up table 140 records 16 codes and 16 program types. The digital sequence 28 includes a header (not shown) for recording one code corresponding to the program type of the digital sequence 28, and the code is one selected from the M codes of the look-up table 140.

According to the aforementioned first preferred embodiment, the processor 18 further includes a video processing module 180 and an audio processing module 182. As shown in FIG. 1, the parser 16 is used for receiving the digital sequence 28, determining a program type recorded in the header of the digital sequence 28 according to the look-up table 140 and outputting the digital sequence 28 as a video sequence 280 and an audio sequence 282, respectively. The video processing module 180 is used for receiving the video sequence 280 and, according to the program type, adjusting the video sequence 280 by a predetermined mode. The audio processing module 182 is used for receiving the audio sequence 282 and, according to the program type, adjusting the audio sequence 282 by the predetermined mode. The aforementioned predetermined mode includes a video adjusting mode and an audio adjusting mode. The video adjusting mode is used for adjusting one selected from the following group: brightness, contrast and color. The audio adjusting mode is used for adjusting one selected from the following group: volume, tone quality and pitch.

For example, if the code recorded in the header of the digital sequence 28 is “0×4”, according to the look-up table 140, the parser 16 will determine the program type of the digital sequence 28 as “Sport” and output the digital sequence 28 as a video sequence 280 and an audio sequence 282, respectively. Afterward, the video processing mode 180 receives and adjusts the video sequence 280 by the video adjusting mode including brightness, contrast, color and other video effects corresponding to the program type of “Sport”, so as to keep the video output in perfect status. At the same time, the audio processing mode 182 receives and adjusts the audio sequence 282 by the audio adjusting mode including volume, tone quality, pitch and other audio effects corresponding to the program type of “Sport”, so as to keep the audio output in perfect status. Accordingly, when the user changes one program type to another, the audio/video output adjusting system 10 will auto-determine the program type of the current inputted audio/video sequence 26 and further utilize the processor 18 to selectively adjust at least one of the video sequence 280 and the audio sequence 282, such that the audio-visual quality of each program can always maintain perfect status.

Furthermore, as shown in FIG. 1, the audio/video output adjusting system 10 further includes a display device 22 and a speaker 24. The display device 22 is used for receiving and displaying the adjusted video sequence 280, and the speaker 24 is used for receiving and broadcasting the adjusted audio sequence 282.

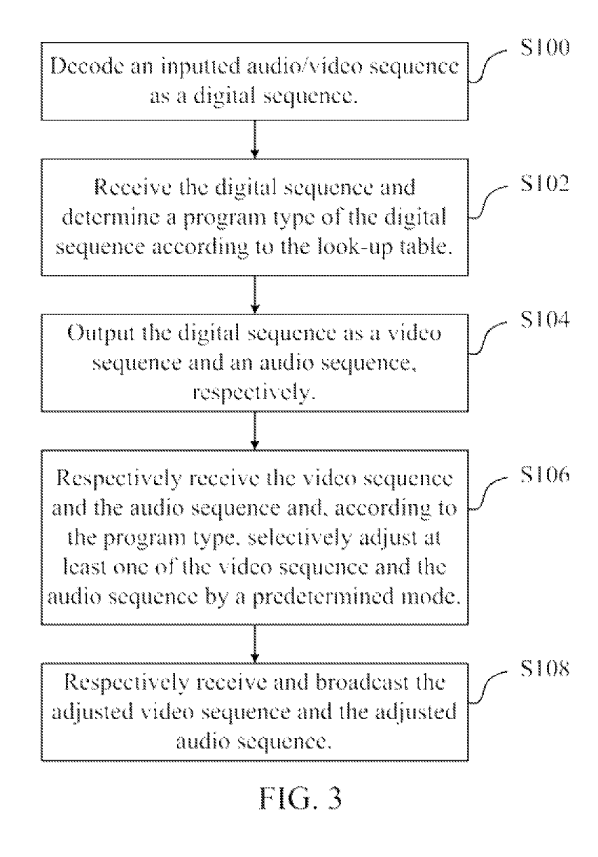

Referring to FIG. 3, FIG. 3 is a flowchart showing the audio/video output adjusting method according to the first preferred embodiment of the invention. According to the aforementioned first preferred embodiment, the audio/video output adjusting method of the invention includes the following steps. At start, step S100 is performed to decode an inputted audio/video sequence as a digital sequence. Afterward, step S102 is performed to receive the digital sequence and determine a program type of the digital sequence according to the look-up table. Step S104 is then performed to output the digital sequence as a video sequence and an audio sequence, respectively. Step S106 is then performed to respectively receive the video sequence and the audio sequence and, according to the program type, selectively adjust at least one of the video sequence and the audio sequence by a predetermined mode. Step S108 is then performed to respectively receive and broadcast the adjusted video sequence and the adjusted audio sequence.

Compared to the prior art, when the user changes one program type to another, the invention will auto-determine the program type of the current inputted audio/video sequence and further utilize the processor to selectively adjust at least one of the video sequence and the audio sequence, such that the audio-visual quality of each program can always maintain perfect status.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. An audio/video output adjusting system comprising:
a decoder for decoding an inputted audio/video sequence as a digital sequence;
a memory unit for storing a look-up table;
a parser for receiving the digital sequence, determining a program type of the digital sequence according to the look-up table and outputting the digital sequence as a video sequence and an audio sequence, respectively; and
a processor for respectively receiving the video sequence and the audio sequence and, according to the program type, selectively adjusting at least one of the video sequence and the audio sequence by a predetermined mode.

2. The system of claim 1, wherein the look-up table records M codes and M program types, each of the M codes is corresponding to one of the M program types, respectively, and M is a natural number.

3. The system of claim 2, wherein the digital sequence comprises a header for recording one code corresponding to the program type of the digital sequence, and the code is one selected from the M codes.

4. The system of claim 1, wherein the processor comprises a video processing module for receiving the video sequence and, according to the program type, adjusting the video sequence by the predetermined mode.

5. The system of claim 4, further comprising a display device for receiving and displaying the adjusted video sequence.

6. The system of claim 1, wherein the processor comprises an audio processing module for receiving the audio sequence and, according to the program type, adjusting the audio sequence by the predetermined mode.

7. The system of claim 6, further comprising a speaker for receiving and broadcasting the adjusted audio sequence.

8. The system of claim 1, wherein the predetermined mode comprises:
a video adjusting mode for adjusting one selected from the following group:
brightness, contrast and color; and
an audio adjusting mode for adjusting one selected from the following group:
volume, tone quality and pitch.

9. The system of claim 1, wherein the memory unit is a flash memory.

10. An audio/video output adjusting method comprising the steps of:
decoding an inputted audio/video sequence as a digital sequence;
receiving the digital sequence and determining a program type of the digital sequence according to the look-up table;
outputting the digital sequence as a video sequence and an audio sequence, respectively; and
respectively receiving the video sequence and the audio sequence and, according to the program type, selectively adjusting at least one of the video sequence and the audio sequence by a predetermined mode.

11. The method of claim 10, wherein the look-up table records M codes and M program types, each of the M codes is corresponding to one of the M program types, respectively, and M is a natural number.

12. The method of claim 11, wherein the digital sequence comprises a header for recording one code corresponding to the program type of the digital sequence, and the code is one selected from the M codes.

13. The method of claim 10, further comprising the step of:
respectively receiving and broadcasting the adjusted video sequence and the adjusted audio sequence.

14. The method of claim 10, wherein the predetermined mode comprises:
a video adjusting mode for adjusting one of the following group: brightness, contrast and color; and
an audio adjusting mode for adjusting one of the following group: volume, tone quality and pitch.

15. The method of claim 10, wherein the look-up table is stored in a flash memory.
